(19) United States
(12) Patent Application Publication
(10) Pub. No.: US 2010/0269942 A1
(43) Pub. Date: Oct. 28, 2010

(54) Dual Layer Pipe

(76) Inventor: Jang-sub LEE, Seoul (KR)

Correspondence Address: North Star Intellectual Property Law, PC, P.O. Box 34688, Washington, DC, 20043, US

(21) Appl. No.: 12/497,530

(22) Filed: Jul. 2, 2009

(30) Foreign Application Priority Data
Jan. 4, 2007 (KR) 10-2007-0001046
Jun. 1, 2007 (KR) PCT/KR2007/002677

(51) Int. Cl. F16L 9/00; B23P 17/00

(52) U.S. Cl. 138/109; 29/527.1; 138/122

(57) ABSTRACT

A corrugated steel pipe with a dual layer, and more particularly, to a corrugated steel pipe with a dual layer, which can dispose a smooth-walled plastic pipe in a corrugated steel pipe more conveniently, thereby providing a simple construction and conveniently assembling corrugated steel pipes while simultaneously improving a coupling force and a sealing force.

### CROSS REFERENCE TO RELATED APPLICATIONS

This utility patent application claims priority to international application PCT/KR2007/002677 filed on Jun. 1, 2007, and Republic of Korea patent application serial number 10-2007-0001046 filed on Jan. 4, 2007, which are hereby incorporated by reference.

### TECHNICAL FIELD

The present invention relates to a dual layer pipe made of two or more types of structural materials, and more particularly, to a pipe system that includes a pipe with a double layer structure, which can more conveniently dispose a smooth-walled plastic pipe in a corrugated steel pipe to provide ease of construction and assembling corrugated steel pipes while simultaneously improving a coupling force and a sealing force.

### BACKGROUND

Underground pipes are typically composed of either concrete or cast iron. Although such concrete pipes including concrete pipes or cast iron pipes can bear a heavy load or an earth pressure, the heaviness and the high volume of the concrete pipes or the cast iron pipes makes transport, construction, and demolition difficult. In addition, since the quality of concrete depends on the curing conditions of the concrete, a poor curing condition such as winter causes defective products with reduced structural strength.

To address these limitations, corrugated steel pipes are used for carrying sewage, supplying municipal and industrial water, and manufacturing concrete void forms and chutes in the construction field. Recently, because of labor shortages, cost increases, and environmental pollution in drain pipe construction, corrugated steel pipes are considered as substitutes for typical concrete pipes, which provide high external strength, durability, structural reliability, economy, and convenient construction.

However, since such a corrugated steel pipe includes a spiral that is disposed in a circumferential direction and normal to a flow direction of a fluid in the corrugated steel pipe, the spiral restricts the general flow of the fluid. Also, such a corrugated steel pipe is formed of steel and usually in contact with a fluid, thus causing corrosion that reduces the lifetime of the pipe.

In addition, a coupling member for coupling corrugated steel pipes is a soft packing member that is pressed on the outer circumferences of the pipes to provide a coupling force and a sealing force. Since the soft packing member is just pressed on the outer circumferences of the pipes, pipe construction is poor and the number of processes is increased, thus causing construction cost increases.

To address these limitations, Korean Patent Publication No. 2004-0049948, entitled “DOUBLE LAYER PIPE AND MANUFACTURING METHOD THEREOF”, filed on Jun. 14, 2004 discloses a double layer pipe including a corrugated steel pipe, a smooth-walled plastic pipe inserted into the corrugated steel pipe, and an adhesive resin filler filled between the smooth-walled plastic pipe and the corrugated steel pipe. The double layer pipe can improve structural reliability to protect the double layer pipe from external damage and improve the flow of a fluid therein, thus preventing corrosion.

However, it is actually difficult to fill the adhesive resin filler between the smooth-walled plastic pipe and the corrugated steel pipe. Also, even when the corrugated steel pipe is formed while the filler is simultaneously formed on the corrugated steel pipe, processing of the filler is difficult. Furthermore, curing causes shrinkage in the filler, thus isolating the filler from the corrugated steel pipe. Also, it is difficult to couple the corrugated steel pipes, thus decreasing productivity.

### SUMMARY

The dual layer pipe helps to solve the above-described problems. An object of the pipe system is to provide a corrugated steel pipe having a dual layer, which can achieve simple and rapid construction by more conveniently providing a smooth-walled plastic pipe in a corrugated steel pipe, thereby reducing costs and increasing production. Furthermore, the corrugated steel pipes, each including the smooth-walled plastic pipe, are more conveniently coupled to each other while simultaneously improving a coupling force and a sealing force. To achieve the objects of the pipe system, there is provided a pipe including a corrugated steel pipe having a predetermined length, an inner circumference on which a spiral protruding portion is formed, and an outer circumference on which a spiral protruding portion is formed, and a smooth-walled plastic pipe inserted into the corrugated steel pipe and coupled to the corrugated steel pipe through a coupling member, characterized in that the coupling member includes: a fixing plate (30) coupled to each both end portions of the corrugated steel pipe (10) and protruding a predetermined height, the corrugated steel pipe (10) including a wing portion (16) having an inclined cross-sectional shape, the fixing plate (30) including an inclined surface (32) tightly pressed on an inner circumference of the wing portion (16) and a horizontal surface (33) provided on a portion of the inclined surface (32) for forming an acute angle with respect to the inclined surface (32), the horizontal surface (33) coupled to an end outer circumference of the smooth-walled plastic pipe (20); a fixing element (40) including one portion tightly pressed on a protruding portion (34) provided on the other portion of the inclined surface (32) for forming an obtuse angle with respect to the inclined surface (32), and the other portion tightly pressed on an outer circumference of the wing portion (16); and an adhesive resin (50) filled in the fixing element (40) for coupling the corrugated steel pipe (10) and the smooth-walled plastic pipe (20).

The corrugated steel pipe (10) may include both end outer circumferences on which a ring-shaped flange (45) tightly pressed on the fixing element (40) is each provided, a plurality of coupling holes (46) are spaced a predetermined distance from each other in a fringe of the flange (45), and the corrugated steel pipe (10) is coupled using bolts passing through the coupling holes (46).

The flange (45) may have a cross-sectional shape of an inverted U to surround a protruding surface (14) of a corrugated portion (12), one end portion tightly pressed on a recessed surface (13) of the corrugated portion (12), and one side tightly pressed on the fixing element (40).

### DESCRIPTION OF THE DRAWINGS

FIG. 1 is a partial enlarged view illustrating a corrugated steel pipe coupled with a smooth-walled plastic pipe.

FIG. 2 is a partial enlarged view illustrating a coupling member for the corrugated steel pipes.

### DETAILED DESCRIPTION

Hereinafter, a corrugated steel pipe having a double or dual structural layer according to one of the embodiments will now be described with reference to the accompanying drawing.

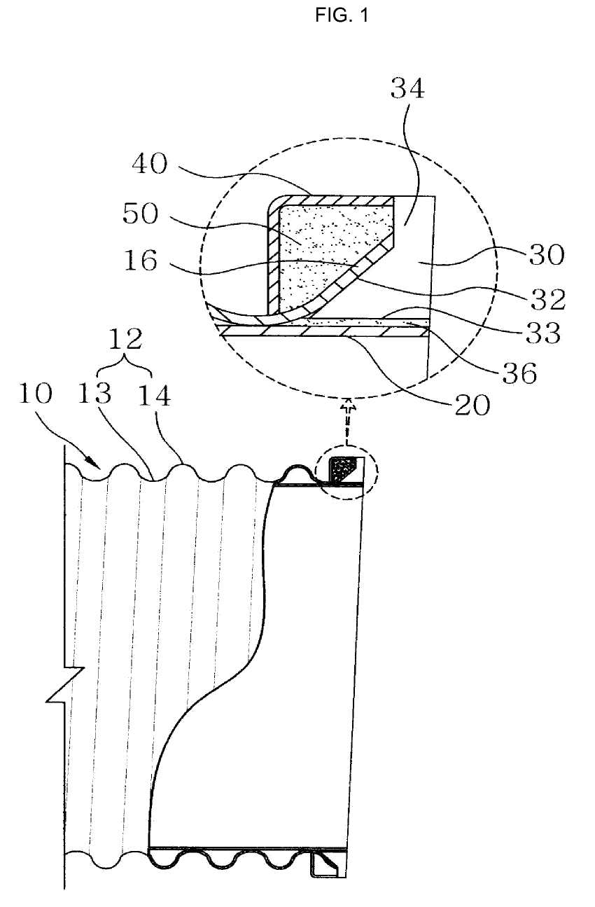

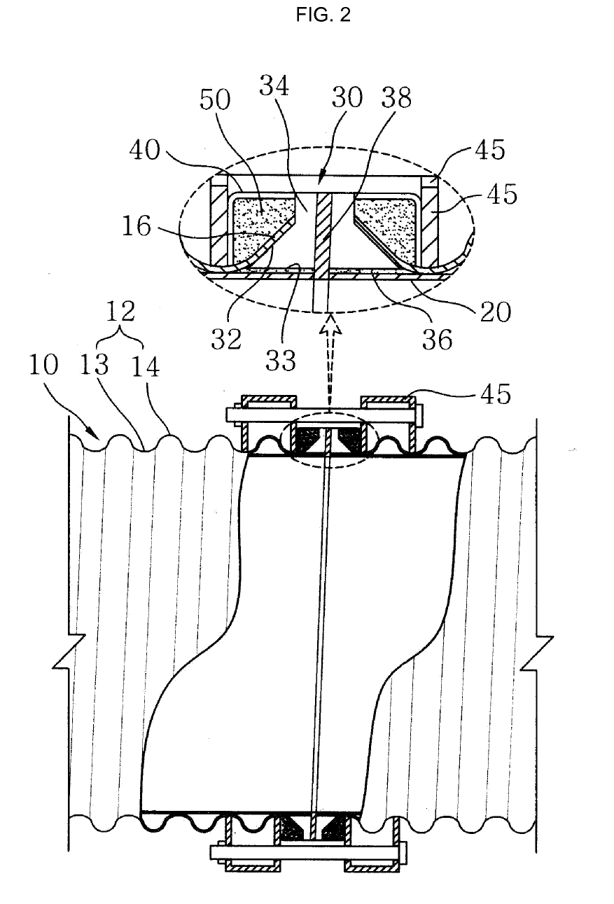

FIG. 1 is a partial enlarged view illustrating a corrugated steel pipe 10 coupled with a smooth-walled plastic pipe. FIG. 2 is a partial enlarged view illustrating the coupling member for the corrugated steel pipe 10 coupled.

Referring to FIGS. 1 and 2, a pipe with a dual layer includes a corrugated steel pipe 10 having a predetermined length, an inner circumference formed with a spiral protruding portion, and an outer circumference formed wtih a spiral protruding portion, a smooth-walled plastic pipe 20 inserted into the corrugated steel pipe 10 and having an outer diameter corresponding to an inner diameter of the corrugated steel pipe 10, and a coupling member configured to couple the smooth-walled plastic pipe 20 to the corrugated steel pipe 10.

The coupling member includes a fixing plate 30 coupled to the smooth-walled plastic pipe 20 and protruding a predetermined height from each end portion of the corrugated steel pipe 10, a fixing element 40 configured to tightly couple the fixing plate to the corrugated steel pipe 10, and an adhesive resin 50 filling in the fixing element 40 for coupling the corrugated steel pipe 10 and the smooth-walled plastic pipe 20.

A fixing plate 30 including an inclined surface 32 and a horizontal surface 33, protrudes from each end portion of the smooth-walled plastic pipe 20. The inclined surface 32 is tightly pressed on an inner circumference of a wing portion 16 of the corrugated steel pipe 10. The wing portion 16 has an inclined cross-sectional shape. The horizontal surface 33 is formed on a portion of the inclined surface 32 to form an acute angle with respect to the inclined surface 32, and coupled to the end portion of the smooth-walled plastic pipe 20 through an adhesive resin 36.

The fixing element 40 for coupling the fixing plate 30 to the corrugated steel pipe 10, includes two portions. The fixing element 40 has a cross-sectional shape with a bent middle portion such as a quarter circle shape or an L shape such that one portion of the fixing element 40 is tightly pressed on a protruding portion 34 formed on the other portion of the inclined surface 32 for forming an obtuse angle with respect to the inclined surface 32, and the other portion of the fixing element 40 is tightly pressed on an outer circumference of the wing portion 16.

The corrugated steel pipe 10 includes each end portion having an outer circumference on which a ring-shaped flange 45 tightly pressed on the fixing element 40 may be provided. A plurality of coupling holes 46 are spaced a predetermined distance from each other in a fringe of the flange 45, and the corrugated steel pipe 10 is coupled using bolts passing through the coupling holes 46.

The flange 45 has a cross-sectional shape of an inverted U to surround a protruding surface 14 of a corrugated portion 12, an end portion tightly pressed on a recessed surface 13 of the corrugated portion 12, and one side tightly pressed on the fixing element 40. When the pipe of the described embodiment is provided in duplicate and the flanges 45 are assembled, an elastic ring-shaped packing member 38 may be provided between the fixing plates 30 to improve a sealing force, thereby preventing the leakage of a fluid.

Alternatively, the fixing plate 30 may be formed of plastic to prevent the leakage of a fluid without using the packing member 38.

The smooth-walled plastic pipe 20 includes a cylindrical smooth-walled pipe formed after performing one of a heat-welding process and a high frequency-welding process on each of a plurality of plastic plates having a predetermined length. It is convenient and economic to manufacture the smooth-walled plastic pipe 20.

The configuration and the effects of the described embodiment will now be described. The corrugated steel pipe 10 with a predetermined diameter is prepared, and then the smooth-walled plastic pipe 20 is inserted into the corrugated steel pipe 10. In here, the smooth-walled plastic pipe 20 has the outer diameter corresponding to the inner diameter of the corrugated steel pipe 10. Then, the horizontal surfaces 33 are coupled to the outer circumferences in the both end portion of the smooth-walled plastic pipe 20 through the adhesive resin 36.

Thereafter, the fixing element 40 is coupled to the protruding portion 34 of the fixing plate 30 and the outer circumference of the wing portion 16 of the corrugated steel pipe 10, and then the adhesive resin 50 is filled in the filling element 40.

When the pipe of the described embodiment is provided in duplicate, the flanges 45 provided on the outer circumference of the corrugated steel pipe 10 are used to couple the corrugated steel pipes 10 to each other. The end portion of the flange 45 is tightly pressed on the recessed surface 13 of the corrugated portion 12 such that the flange 45 surrounds the protruding surface 14 of the corrugated portion 12 of the corrugated steel pipes 10, and then the flanges 45 are coupled using bolts.

When the flanges 45 are coupled to each other, the packing member 38 is provided between the fixing plates 30 to prevent the leakage of a fluid. Therefore, the smooth-walled plastic pipe 20 can increase the durability of the corrugated steel pipe 10, prevent the breakage of the corrugated steel pipe 10, improve a flow of a fluid therein, and prevent the fluid from contacting the corrugated steel pipe 10, thereby increasing the lifetime of the corrugated steel pipe 10.

As described above, according to one of the embodiments, the smooth-walled plastic pipe is more conveniently provided in the corrugated steel pipe, thereby achieving simple and rapid construction, reducing costs, and increasing production. Furthermore, the corrugated steel pipes, each including the smooth-walled plastic pipe, are conveniently coupled to each other while simultaneously improving a coupling force and a sealing force.

1. A pipe system, comprising:
a corrugated steel pipe having a predetermined length, an inner circumference on which a spiral protruding portion is disposed, and an outer circumference on which a spiral protruding portion is disposed;
a smooth-walled plastic pipe inserted into the corrugated steel pipe;
a coupling member that couples the corrugated steel pipe to the smooth-walled plastic pipe, the coupling member comprising
a fixing plate coupled to both end portions of the corrugated steel pipe and protruding a predetermined height, the corrugated steel pipe including a wing portion having an inclined cross-sectional shape, the fixing plate including an inclined surface tightly pressed on an inner circumference of the wing portion and a horizontal surface provided on a portion of the inclined surface for forming an acute angle with respect to the inclined surface, the horizontal surface coupled to an end outer circumference of the smooth-walled plastic pipe,
a fixing element including one portion tightly pressed on a protruding portion provided on the other portion of the inclined surface for forming an obtuse angle with respect to the inclined surface, and the other portion tightly pressed on an outer circumference of the wing portion, and
an adhesive resin filled in the fixing element for coupling the corrugated steel pipe and the smooth-walled plastic pipe.

2. The pipe system of claim 1, wherein each end of the corrugated steel pipe comprises an outer circumference on which a ring-shaped flange is pressed on the fixing element, a plurality of coupling holes are spaced a predetermined distance from each other in a fringe of the flange, and the corrugated steel pipe is coupled using bolts passing through the coupling holes.

3. The pipe system of claim 2, wherein the flange has a cross-sectional shape of an inverted U to surround a protruding surface of a corrugated portion, one end portion tightly pressed on a recessed surface of the corrugated portion, and one side tightly pressed on the fixing element.

4. The pipe system of claim 1, wherein the smooth-walled plastic pipe comprises a cylindrical shape after performing one of a heat-welding process and a high frequency-welding process on each of plastic plates having a predetermined length.

5. A coupling member that couples a corrugated outer pipe to a smooth-walled inner pipe, the coupling member comprising:
a fixing plate coupled to end portions of the corrugated outer pipe and protruding a predetermined height, the fixing plate including an inclined surface pressed on an inner circumference of the corrugated outer pipe and a horizontal surface provided on a portion of an inclined surface of the corrugated outer pipe to form an acute angle with respect to the inclined surface, the horizontal surface coupled to an outer circumference of the smooth-walled inner pipe; and
a fixing element including one portion pressed on a protruding portion provided on the other portion of the inclined surface to form an obtuse angle with respect to the inclined surface, and the other portion pressed on an outer circumference of the corrugated outer pipe.

6. The coupling member of claim 5, further comprising:
an adhesive resin applied to the fixing element to bond the corrugated outer pipe to the smooth-walled inner pipe.

7. A method of installing a dual layer pipe that includes a corrugated steel pipe, a smooth-walled plastic pipe, a coupling member, a fixing plate, and a fixing element, the method comprising:
inserting the smooth-walled plastic pipe into the corrugated steel pipe;
attaching the fixing plate to the smooth-walled plastic pipe;
coupling the fixing plate to the corrugated steel pipe; and
filling the fixing element with an adhesive resin to bond the corrugated steel pipe to the smooth-walled plastic pipe.

8. The method of claim 7, further comprising providing the fixing plate with an inclined surface and a horizontal surface that protrude from each end portion of the smooth-walled pipe; and wherein coupling includes pressing the inclined surface on an inner circumference of the corrugated steel pipe.

9. The method of claim 7, further comprising:
inserting packing members between fixing plates of each section of the dual layer pipe; and
attaching sections of the dual layer pipe with bolts that pass through coupling holes.
